(19) United States
(12) Patent Application Publication
(10) Pub. No.: US 2026/0279049 A1
(43) Pub. Date: Sep. 17, 2026

(54) Video Content Analysis System

(71) Applicant: SoftBank Group Corp., Tokyo (JP)

(72) Inventor: Shoei TAKEMOTO, Tokyo (JP)

(21) Appl. No.: 19/561,519

(22) Filed: Mar. 10, 2026

Related U.S. Application Data
(60) Provisional application No. 63/769,766, filed on Mar. 11, 2025.

(51) Int. Cl. G06V 20/40; G06F 40/40; G06V 20/70; G06V 40/10; G06V 40/20

(52) U.S. Cl. CPC G06V 20/41; G06F 40/40; G06V 20/46; G06V 20/70; G06V 40/10; G06V 40/20

(57) ABSTRACT

The present disclosure relates to a system that analyzes video content and outputs the content thereof as audio. The system includes an input unit that inputs video content, an analysis unit that extracts features in the video, a generation unit that generates description text in natural language, a speech synthesis unit that converts the text into audio, and an output unit that outputs the audio. The analysis unit analyzes frames of the video using computer vision technology to identify a person, an object, a background, and an action. The generation unit generates description text using natural language processing technology, and the speech synthesis unit converts this into natural speech.

### CROSS-REFERENCE TO RELATED APPLICATION

This application claims the benefit of priority from U.S. Provisional Patent Application No. 63/769,766, filed on Mar. 11, 2025. The entire contents of the priority application are incorporated herein by reference.

### BACKGROUND

The technology of the present disclosure relates to a system.

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is a problem that it is difficult to efficiently grasp the content of video content without relying on vision. In particular, for visually impaired people and busy modern people, visually consuming video content is accompanied by difficulties due to time constraints and physical constraints. For this reason, a means for understanding the content of video with audio is demanded. In the related art, there has been a problem that it is necessary to manually create an audio description for explaining the content of video in detail, which takes time and effort, and in addition, real-time response is difficult. The present disclosure aims to solve these problems by combining a video analysis AI and a generative AI to automatically analyze the content of video content, generate a description in natural language, and output it as audio. This makes it possible for not only visually impaired people but also people who value time efficiency to quickly and accurately understand the content of video content. Furthermore, an important feature of the present disclosure is that by realizing real-time video analysis and audio output, it is applicable to live video and streaming content, and can support a wide range of use scenes.

As a means for solving the problem, the present disclosure provides a system that analyzes video content and outputs the content thereof as audio. This system includes an input unit that inputs video content, an analysis unit that analyzes the input video content and extracts features in the video, a generation unit that generates description text in natural language based on the extracted features, a speech synthesis unit that converts the generated description text into audio, and an output unit that outputs the audio generated by the speech synthesis unit. The input unit receives video content such as television or video-on-demand in a digital format and transmits it to the analysis unit. The analysis unit analyzes each frame of the video using computer vision technology, identifies important visual elements such as a person, an object, a background, and an action, and extracts a feature image or a feature video. The generation unit generates description text using natural language processing technology based on the feature image or the feature video extracted by the analysis unit, and visually explains the content of the video. The speech synthesis unit converts the generated description text into natural speech and provides it to a user through the output unit. In this way, it becomes possible to grasp the content of video content without relying on vision, and a useful information provision means is realized for visually impaired people and people who value time performance.

Furthermore, as a technical problem in conventional audio description technology, a problem of “Synchronization” between the transition speed of video frames and the generation/playback speed of audio description can be cited. In video content, particularly in live streaming, if the provision of audio information is delayed with respect to changes in visual information, it becomes a risk of impairing the user's experience. However, performing high-precision image recognition and natural language generation in series imposes a high calculation load, and latency (delay) is likely to occur. The present disclosure guarantees real-time performance while optimizing calculation resources by introducing an algorithm that parallelizes calculation processing of feature quantity vectors extracted from video frames and vectors on a pre-learned emotion map, and dynamically adjusts the length of generated description text according to an “available Time Window” until the next scene transition.

### BRIEF DESCRIPTION OF DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method for analyzing video content.

### DETAILED DESCRIPTION

Hereinafter, an example of an embodiment of a system according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be only A, may be only B, or may be a combination of A and B. Also, in the present specification, when three or more matters are expressed by being connected with “and/or”, the same concept as “A and/or B” is applied.

### First Embodiment

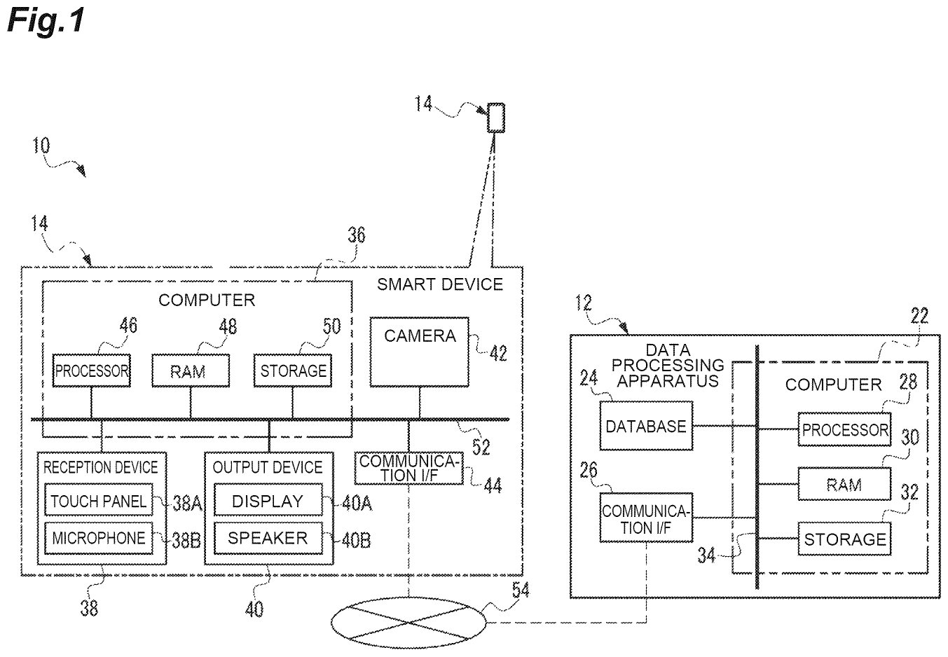

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a form perceivable by the user 20 (for example, voice and/or text). The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

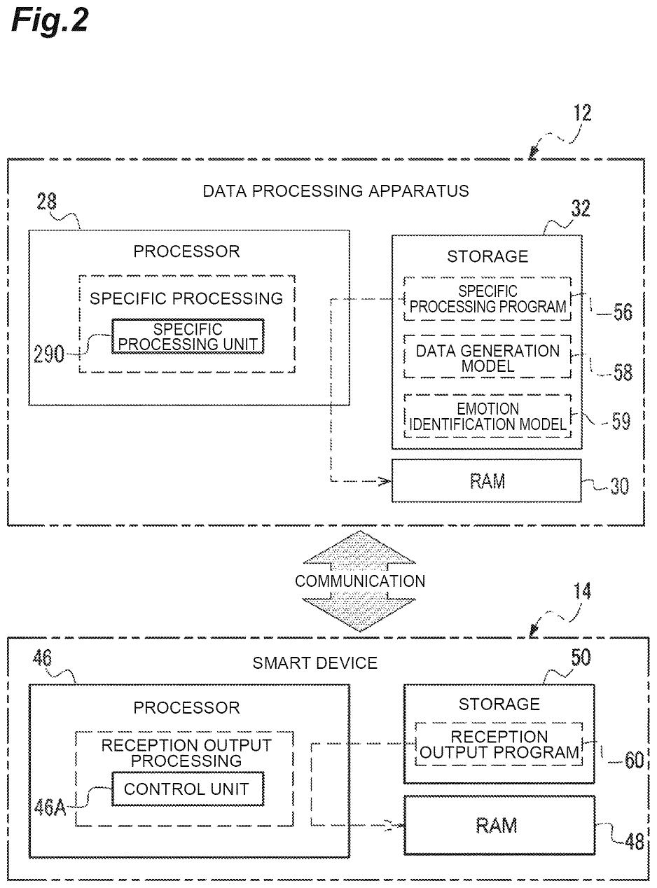

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the specific processing program 60 executed on the RAM 48. Note that the smart device 14 may have a data generation model and an emotion identification model similar to the data generation model 58 and the emotion identification model 59, and can also perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

As an embodiment, a case where an automatic secondary audio generation system for video content is realized by a server and a terminal will be described more specifically and in detail.

First, a terminal provides a user interface and includes a means for a user to select video content that the user wants to watch. The terminal is a device such as a television, a smartphone, a tablet, or a personal computer, and includes an input unit for a user to input video content. The input unit may be configured by, for example, the reception device 38. For example, when a user selects a movie from a video-on-demand service, the terminal accepts the selection and transmits video data to a server. At this time, the terminal can also transmit metadata of the video data, for example, a title, a genre, a playback time, and the like, to the server.

The server is provided with powerful computing capability for executing a video analysis AI, and includes an analysis unit that analyzes input video content. The analysis unit may be configured by, for example, the specific processing unit 290, the specific processing program 56, the data generation model 58, and the emotion identification model 59. The analysis unit on the server analyzes each frame of the video using computer vision technology and identifies important visual elements such as a person, an object, a background, and an action. For example, in a scene of a movie where a main character is driving a car, the analysis unit identifies the face of the main character, the model of the car, and the driving action, and extracts these as feature images. Furthermore, the analysis unit can also recognize text information in the video, for example, signs, subtitles, and the like, and can utilize this for description.

The specific processing unit 290 (analysis unit) executes a feature extractor such as a Convolutional Neural Network (CNN) on input video frames using the processor 28 (for example, a parallel arithmetic processor such as a GPU or NPU), and converts each frame into a multidimensional feature vector. At this time, the specific processing unit 290 may temporarily store difference data between continuous frames in a buffer area on the RAM 30, extract only cases where the difference exceeds a predetermined threshold as “key frames”, and execute “thinning processing” to use them as input to the data generation model 58 (LLM, etc.). Thereby, the bandwidth of the network 54 and the calculation load of the processor 28 are reduced. Also, the data generation model 58 receives, as an input tensor, a concatenation of the extracted feature vector and an emotion vector output from the emotion identification model 59 based on a Transformer architecture, and generates description text.

Next, a generation unit on the server generates description text using natural language processing technology based on the feature image or the feature video extracted by the analysis unit. The generation unit may be configured by, for example, the specific processing unit 290, the specific processing program 56, the data generation model 58, and the emotion identification model 59. The generation unit generates sentences that describe in detail changes in scenes and actions of characters in the video. For example, in a scene where the main character is driving a car, it generates description text such as “The main character is driving a red sports car and speeding through the city”. Furthermore, the generation unit can also consider the emotional tone of the video, changes in background music, and the like, and can provide a richer description.

The generated description text is transmitted from the server to the terminal and is converted into audio by a speech synthesis unit on the terminal. The speech synthesis unit may be configured by, for example, the computer 36 and the output device 40. The speech synthesis unit converts the description text into audio with a natural intonation and provides it to the user. For example, when the terminal is a smartphone, the audio is output from the speaker of the smartphone, and the user can also listen to the audio through earphones. The speech synthesis unit can adjust the tone and speed of the voice according to the user's preference, and provides audio output optimized for each individual user.

In this way, through the cooperation of the server and the terminal, it becomes possible to grasp the content of video content without relying on vision, and a useful information provision means is realized for visually impaired people and people who value time performance. Furthermore, by utilizing the high computing capability of the server, real-time video analysis and audio output become possible, and it is also applicable to live video and streaming content. This allows users to efficiently consume a variety of content. Also, the system can support multiple languages, and can generate a description and output audio for content in different languages through the same process. This makes it possible to support an international user base.

### (System Configuration)

The system according to the present embodiment includes an input unit, an analysis unit, a generation unit, a speech synthesis unit, and an output unit. The input unit has a function for a user to select video content that the user wants to watch and to import it into the system. Specifically, a user can select video from a video-on-demand service or a streaming platform via a device such as a television, a smartphone, a tablet, or a personal computer. For example, when a user selects a movie, the input unit receives the digital data of the movie and transmits metadata such as a title, a genre, and a playback time to a server. This process prepares the system to process appropriate video data based on the user's selection.

The analysis unit has a role of receiving video data transmitted from the input unit and identifying important visual elements in the video. The analysis unit analyzes each frame of the video in detail using computer vision technology and identifies a person, an object, a background, an action, and the like. For example, in a scene of a movie where a main character is driving a car, the analysis unit recognizes the face of the main character, identifies the model of the car, and analyzes the driving action. Also, the analysis unit can recognize text information in the video, for example, signs and subtitles, and can utilize this for description. Furthermore, the analysis unit detects the emotional tone of the video and changes in background music, and provides this information to the generation unit.

The generation unit generates description text using natural language processing technology based on the feature image or the feature video and information extracted by the analysis unit. The generation unit generates sentences that describe in detail changes in scenes and actions of characters in the video. For example, in a scene where the main character is driving a car, it generates description text such as “The main character is driving a red sports car and speeding through the city”. The generation unit can also consider the emotional tone of the video and changes in background music, and can provide a richer description. A specific example of a prompt sentence to be read into the generative AI includes an instruction such as, “In this scene, please describe in detail what action the main character is taking. Please also take into account the background music and emotional tone.”

The speech synthesis unit has a role of converting the description text generated by the generation unit into audio. The speech synthesis unit converts the description text into audio with a natural intonation and provides it to a user. For example, the speech synthesis unit can adjust the tone and speed of the voice according to the user's preference, and provides audio output optimized for each individual user. The speech synthesis unit generates audio for content in different languages through the same process, and can support multiple languages.

The output unit has a function for providing the audio generated by the speech synthesis unit to a user. The output unit outputs audio through a speaker or earphones of a terminal, so that the user can grasp the content of video content without relying on vision. For example, when outputting audio from the speaker of a smartphone, the user can also listen to the audio privately using earphones. The output unit can adjust the volume and sound quality according to the user's environment, and provides an optimal audio experience.

In this way, through the cooperation of the server and the terminal, it becomes possible to efficiently grasp the content of video content, and a useful information provision means is realized for visually impaired people and people who value time performance. Furthermore, real-time video analysis and audio output are possible, and it is also applicable to live video and streaming content. This allows users to efficiently consume a variety of content.

### (Implementation Steps)

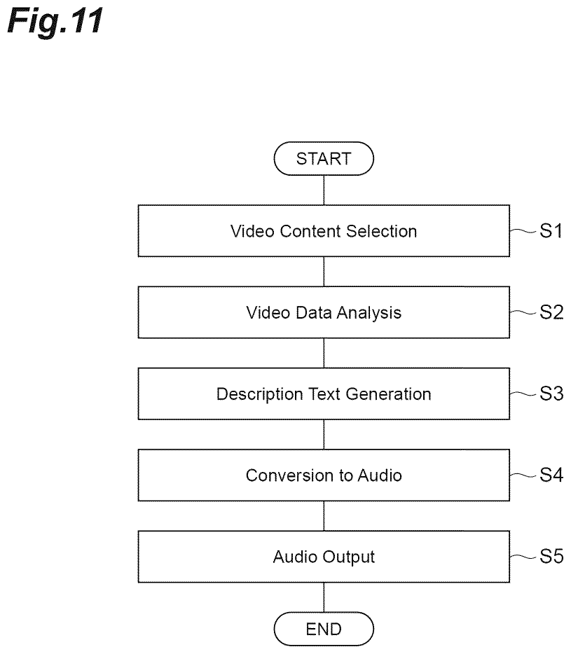

### Step 1: Video Content Selection (See Step S1 in FIG. 11)

A user selects video content that the user wants to watch via a terminal. The terminal is a device such as a television, a smartphone, a tablet, or a personal computer, and the user can select video from a video-on-demand service or a streaming platform. For example, when a user selects a movie, the terminal receives the digital data of the movie and transmits metadata such as a title, a genre, and a playback time to a server. This process prepares the system to process appropriate video data based on the user's selection.

### Step 2: Video Data Analysis (See Step S2 in FIG. 11)

A server receives the video data transmitted from the input unit and identifies important visual elements in the video. The analysis unit analyzes each frame of the video in detail using computer vision technology and identifies a person, an object, a background, an action, and the like. For example, in a scene of a movie where a main character is driving a car, the analysis unit recognizes the face of the main character, identifies the model of the car, and analyzes the driving action. Also, the analysis unit can recognize text information in the video, for example, signs and subtitles, and can utilize this for description. Furthermore, the analysis unit detects the emotional tone of the video and changes in background music, and provides this information to the generation unit.

### Step 3: Description Text Generation (See Step S3 in FIG. 11)

The generation unit generates description text using natural language processing technology based on the feature image or the feature video and information extracted by the analysis unit. The generation unit generates sentences that describe in detail changes in scenes and actions of characters in the video. For example, in a scene where the main character is driving a car, it generates description text such as “The main character is driving a red sports car and speeding through the city”. The generation unit can also consider the emotional tone of the video and changes in background music, and can provide a richer description. A specific example of a prompt sentence to be read into the generative AI includes an instruction such as, “In this scene, please describe in detail what action the main character is taking. Please also take into account the background music and emotional tone.”

### Step 4: Conversion to Audio (See Step S4 in FIG. 11)

The speech synthesis unit converts the description text generated by the generation unit into audio. The speech synthesis unit converts the description text into audio with a natural intonation and provides it to a user. For example, the speech synthesis unit can adjust the tone and speed of the voice according to the user's preference, and provides audio output optimized for each individual user. The speech synthesis unit generates audio for content in different languages through the same process, and can support multiple languages.

### Step 5: Audio Output (See Step S5 in FIG. 11)

The output unit has a function for providing the audio generated by the speech synthesis unit to a user. The output unit outputs audio through a speaker or earphones of a terminal, so that the user can grasp the content of video content without relying on vision. For example, when outputting audio from the speaker of a smartphone, the user can also listen to the audio privately using earphones. The output unit can adjust the volume and sound quality according to the user's environment, and provides an optimal audio experience.

### (Specific Use Case)

For example, consider a case where a user with a visual impairment wants to watch the latest movie and accesses a video-on-demand service using a smartphone. This user selects a movie through an application on the smartphone and starts watching. The smartphone transmits the digital data of the selected movie to a server, and also simultaneously transmits metadata such as the movie's title, genre, and playback time.

The server processes the received video data in an analysis unit and analyzes each frame of the movie using computer vision technology. The analysis unit recognizes the main characters in the movie and identifies their actions and facial expressions. Also, it identifies the background and objects in the movie scenes, for example, cars, buildings, and natural landscapes. Furthermore, the analysis unit extracts text information such as subtitles and signs in the movie and utilizes this for description.

The information extracted by the analysis unit is passed to a generation unit, and the generation unit generates description text using natural language processing technology. The generation unit generates sentences that describe in detail changes in scenes and actions of characters in the movie. For example, it generates a description such as, “The main character is driving a red sports car and speeding against the backdrop of a city night view”. A specific example of a prompt sentence to be read into the generative AI includes an instruction such as, “In this scene, please describe the actions of the characters and the details of the background. In particular, please consider the influence of the emotional tone and music.”

The generated description text is transmitted to the smartphone and is converted into audio by a speech synthesis unit. The speech synthesis unit converts the description text into audio with a natural intonation and provides it to the user. The audio is output from the speaker of the smartphone, and the user can also listen to the audio privately using earphones. The speech synthesis unit adjusts the tone and speed of the voice according to the user's preference and provides audio output optimized for each individual user.

In this way, a user with a visual impairment can grasp the visual content of a movie with audio and can enjoy the movie. This system realizes real-time video analysis and audio output, and is also applicable to live video and streaming content. This allows users to efficiently consume a variety of content.

### Application Example 1

A flow of specific processing in Application Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

An embodiment will be described more specifically and in detail. The present disclosure is a system that enables elderly people with visual impairments and people who need care to grasp visual information in their daily lives with audio, and is intended for use in homes and nursing care facilities. This system includes a plurality of cameras, an analysis unit, a generation unit, a speech synthesis unit, and an output unit.

First, a camera unit is installed in a home or a nursing care facility and acquires video in real time. The cameras are attached to a ceiling or a wall and are arranged so as to overlook the entire room. For example, a camera installed in a living room constantly monitors the arrangement of furniture such as a sofa, a table, and a television. Also, a camera installed in a hallway tracks the movement of a user and provides information for preventing dangers such as falls. Furthermore, a camera installed in a kitchen can monitor the situation during cooking and issue a warning to prevent forgetting to turn off a fire or misuse of cooking utensils.

Next, the analysis unit receives the video acquired from the camera unit and identifies important elements in the video using computer vision technology. The analysis unit identifies the arrangement of furniture, objects placed on the floor, the positions of windows and doors, and the presence of other people. For example, when there is a sofa in a room, the analysis unit identifies its position and urges the user to be careful not to bump into the sofa. Also, the analysis unit can recognize text information in the video, for example, signs and subtitles, and can utilize this for description. Furthermore, the analysis unit detects the emotional tone of the video and changes in background music, and provides this information to the generation unit. For example, when a user is listening to music, the analysis unit analyzes the genre and tempo of the music and can provide guidance according to the user's mood.

The generation unit generates description text that provides guidance for a user to move safely, based on the information extracted by the analysis unit. The generation unit generates a description including specific movement instructions based on the user's current position and destination. For example, it generates an instruction such as, “There is a sofa on the right side. There is a table on the left side. If you proceed forward, there is a window. Please turn right before the window.” A specific example of a prompt sentence to be read into the generative AI includes an instruction such as, “In this scene, please describe the actions of the characters and the details of the background. In particular, please consider the influence of the emotional tone and music.” Furthermore, the generation unit can provide more personalized guidance based on the user's past behavior history and preferences.

The speech synthesis unit converts the description text generated by the generation unit into natural speech. The speech synthesis unit converts the description text into audio with a natural intonation and provides it to the user. The audio is output through earphones or a speaker so as to reach the user's ears directly. The speech synthesis unit adjusts the tone and speed of the voice according to the user's preference and provides audio output optimized for each individual user. For example, when the user is an elderly person, the speech synthesis unit is adjusted to pronounce clearly at a slow speed.

The output unit has a function for providing the audio generated by the speech synthesis unit to the user. The output unit can adjust the volume and sound quality according to the user's environment, and provides an optimal audio experience. For example, when outputting audio from the speaker of a smartphone, the user can also listen to the audio privately using earphones. Furthermore, the output unit can continue to provide audio guidance without interruption even when the user moves between a plurality of rooms.

In this way, through the cooperation of the server and the terminal, it becomes possible to grasp the content of video content without relying on vision, and a useful information provision means is realized for visually impaired people and people who value time performance. Furthermore, real-time video analysis and audio output are possible, and it is also applicable to live video and streaming content. This allows users to efficiently consume a variety of content. Also, the system can support multiple languages, and can generate a description and output audio for content in different languages through the same process. This makes it possible to support an international user base.

### (System Configuration)

The system according to the present embodiment includes a camera unit, an analysis unit, a generation unit, a speech synthesis unit, and an output unit. The camera unit has a function of being installed in a home or a nursing care facility and acquiring video in real time. The cameras are attached to a ceiling or a wall and are arranged so as to overlook the entire room. For example, a camera installed in a living room constantly monitors the arrangement of furniture such as a sofa, a table, and a television. Also, a camera installed in a hallway tracks the movement of a user and provides information for preventing dangers such as falls. Furthermore, a camera installed in a kitchen can monitor the situation during cooking and issue a warning to prevent forgetting to turn off a fire or misuse of cooking utensils. A camera installed in a bathroom identifies slippery places and urges caution so that the user can bathe safely.

The analysis unit has a function of receiving the video acquired from the camera unit and identifying important elements in the video using computer vision technology. The analysis unit identifies the arrangement of furniture, objects placed on the floor, the positions of windows and doors, and the presence of other people. For example, when there is a sofa in a room, the analysis unit identifies its position and urges the user to be careful not to bump into the sofa. Also, the analysis unit can recognize text information in the video, for example, signs and subtitles, and can utilize this for description. Furthermore, the analysis unit detects the emotional tone of the video and changes in background music, and provides this information to the generation unit. For example, when a user is listening to music, the analysis unit analyzes the genre and tempo of the music and can provide guidance according to the user's mood. The analysis unit can also learn the user's movement patterns and issue a warning when an abnormal movement is detected.

The analysis unit may further include an “anomaly detection module”. This module calculates a movement vector of a user or a surrounding object from time-series video data acquired from the camera 42, and detects in real time a movement deviating from a normal movement pattern (normal distribution) (e.g., a sudden acceleration change suggesting a fall, detection of an intruder) using an unsupervised learning algorithm such as Isolation Forest or LSTM Autoencoder. When an anomaly is detected, the generation unit interrupts a normal description generation process, preferentially selects a short command for emergency warning (e.g., “Stop”, “Evade to the right”) pre-cached in the RAM 48, and sends it to the speech synthesis unit. At the same time, the communication I/F 44 performs control to encrypt and immediately transmit a video clip and position information at the time of anomaly occurrence to a pre-registered caregiver terminal or security server using a specific communication protocol (e.g., MQTT or WebSocket).

The generation unit has a function of generating description text that provides guidance for a user to move safely, based on the information extracted by the analysis unit. The generation unit generates a description including specific movement instructions based on the user's current position and destination. For example, it generates an instruction such as, “There is a sofa on the right side. There is a table on the left side. If you proceed forward, there is a window. Please turn right before the window.” A specific example of a prompt sentence to be read into the generative AI includes an instruction such as, “In this scene, please describe the actions of the characters and the details of the background. In particular, please consider the influence of the emotional tone and music.” Furthermore, the generation unit can provide more personalized guidance based on the user's past behavior history and preferences. For example, if the user prefers to use a specific route, it guides that route with priority.

The speech synthesis unit has a function of converting the description text generated by the generation unit into natural speech. The speech synthesis unit converts the description text into audio with a natural intonation and provides it to the user. The audio is output through earphones or a speaker so as to reach the user's ears directly. The speech synthesis unit adjusts the tone and speed of the voice according to the user's preference and provides audio output optimized for each individual user. For example, when the user is an elderly person, the speech synthesis unit is adjusted to pronounce clearly at a slow speed. Also, the speech synthesis unit can support multiple languages and can provide appropriate audio guidance to users of different languages.

The output unit has a function for providing the audio generated by the speech synthesis unit to the user. The output unit can adjust the volume and sound quality according to the user's environment, and provides an optimal audio experience. For example, when outputting audio from the speaker of a smartphone, the user can also listen to the audio privately using earphones. Furthermore, the output unit can continue to provide audio guidance without interruption even when the user moves between a plurality of rooms. The output unit can also receive user feedback and collect data for improving the content and method of the audio guidance.

In this way, through the cooperation of the server and the terminal, it becomes possible to grasp the content of video content without relying on vision, and a useful information provision means is realized for visually impaired people and people who value time performance. Furthermore, real-time video analysis and audio output are possible, and it is also applicable to live video and streaming content. This allows users to efficiently consume a variety of content. Also, the system can support multiple languages, and can generate a description and output audio for content in different languages through the same process. This makes it possible to support an international user base.

### (Implementation Steps)

### Step 1: Video Acquisition

A camera unit is installed in a home or a nursing care facility and acquires video in real time. The cameras are attached to a ceiling or a wall and are arranged so as to overlook the entire room. For example, a camera installed in a living room constantly monitors the arrangement of furniture such as a sofa, a table, and a television. Also, a camera installed in a hallway tracks the movement of a user and provides information for preventing dangers such as falls. Furthermore, a camera installed in a kitchen can monitor the situation during cooking and issue a warning to prevent forgetting to turn off a fire or misuse of cooking utensils.

### Step 2: Video Analysis

The analysis unit receives the video acquired from the camera unit and identifies important elements in the video using computer vision technology. The analysis unit identifies the arrangement of furniture, objects placed on the floor, the positions of windows and doors, and the presence of other people. For example, when there is a sofa in a room, the analysis unit identifies its position and urges the user to be careful not to bump into the sofa. Also, the analysis unit can recognize text information in the video, for example, signs and subtitles, and can utilize this for description. Furthermore, the analysis unit detects the emotional tone of the video and changes in background music, and provides this information to the generation unit.

### Step 3: Description Text Generation

The generation unit generates description text that provides guidance for a user to move safely, based on the information extracted by the analysis unit. The generation unit generates a description including specific movement instructions based on the user's current position and destination. For example, it generates an instruction such as, “There is a sofa on the right side. There is a table on the left side. If you proceed forward, there is a window. Please turn right before the window.” A specific example of a prompt sentence to be read into the generative AI includes an instruction such as, “In this scene, please describe the actions of the characters and the details of the background. In particular, please consider the influence of the emotional tone and music.”

### Step 4: Audio Conversion

The speech synthesis unit converts the description text generated by the generation unit into natural speech. The speech synthesis unit converts the description text into audio with a natural intonation and provides it to the user. The audio is output through earphones or a speaker so as to reach the user's ears directly. The speech synthesis unit adjusts the tone and speed of the voice according to the user's preference and provides audio output optimized for each individual user.

### Step 5: Audio Output

The output unit has a function for providing the audio generated by the speech synthesis unit to the user. The output unit can adjust the volume and sound quality according to the user's environment, and provides an optimal audio experience. For example, when outputting audio from the speaker of a smartphone, the user can also listen to the audio privately using earphones. Furthermore, the output unit can continue to provide audio guidance without interruption even when the user moves between a plurality of rooms.

### (Specific Use Case)

For example, consider a case where an elderly person with a visual impairment uses the system of the present disclosure to live safely at home. This system installs a plurality of cameras in the home and acquires video in real time. The cameras are placed in the living room, kitchen, hallway, bathroom, and the like, and monitor the situation in each room in detail. The camera in the living room identifies the positions of the sofa and table and urges the user to be careful not to bump into the furniture. The camera in the kitchen monitors the situation during cooking and issues a warning to prevent forgetting to turn off a fire or misuse of cooking utensils. The camera in the hallway tracks the user's movement and provides information to prevent the risk of falls. The camera in the bathroom identifies slippery places and urges caution so that the user can bathe safely.

The analysis unit receives the video acquired from the cameras and identifies important elements using computer vision technology. The analysis unit identifies the arrangement of furniture, objects placed on the floor, the positions of windows and doors, and the presence of other people. For example, when there is a sofa in a room, the analysis unit identifies its position and urges the user to be careful not to bump into the sofa. Also, the analysis unit can recognize text information in the video, for example, signs and subtitles, and can utilize this for description. Furthermore, the analysis unit detects the emotional tone of the video and changes in background music, and provides this information to the generation unit.

The generation unit generates description text that provides guidance for a user to move safely, based on the information extracted by the analysis unit. The generation unit generates a description including specific movement instructions based on the user's current position and destination. For example, it generates an instruction such as, “There is a sofa on the right side. There is a table on the left side. If you proceed forward, there is a window. Please turn right before the window.” A specific example of a prompt sentence to be read into the generative AI includes an instruction such as, “In this scene, please describe the actions of the characters and the details of the background. In particular, please consider the influence of the emotional tone and music.”

The speech synthesis unit converts the description text generated by the generation unit into natural speech. The speech synthesis unit converts the description text into audio with a natural intonation and provides it to the user. The audio is output through earphones or a speaker so as to reach the user's ears directly. The speech synthesis unit adjusts the tone and speed of the voice according to the user's preference and provides audio output optimized for each individual user.

The output unit has a function for providing the audio generated by the speech synthesis unit to the user. The output unit can adjust the volume and sound quality according to the user's environment, and provides an optimal audio experience. For example, when outputting audio from the speaker of a smartphone, the user can also listen to the audio privately using earphones. Furthermore, the output unit can continue to provide audio guidance without interruption even when the user moves between a plurality of rooms.

In this way, an elderly person with a visual impairment can safely and independently perform movements and daily life activities at home. The system of the present disclosure improves the user's quality of life and provides an environment where the user can live with peace of mind.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart device 14.

### Second Embodiment

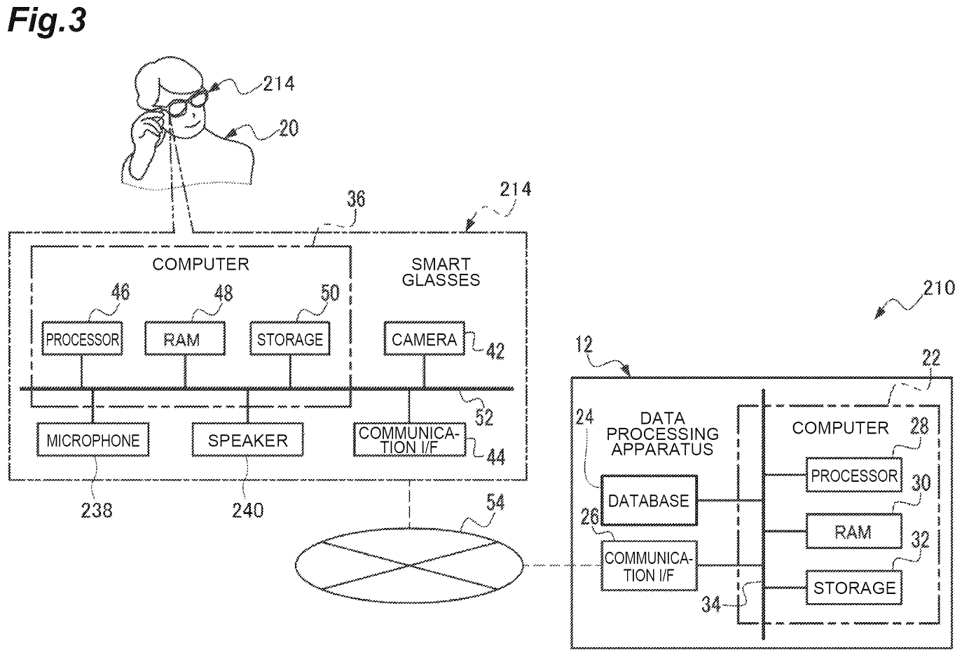

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

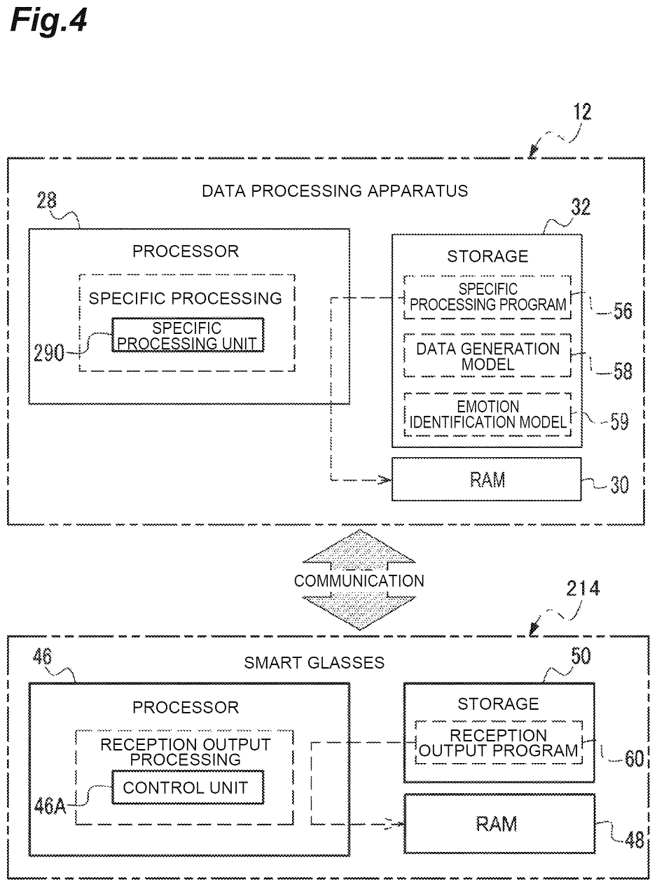

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 may have a data generation model and an emotion identification model similar to the data generation model 58 and the emotion identification model 59, and can also perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart glasses 214.

### Third Embodiment

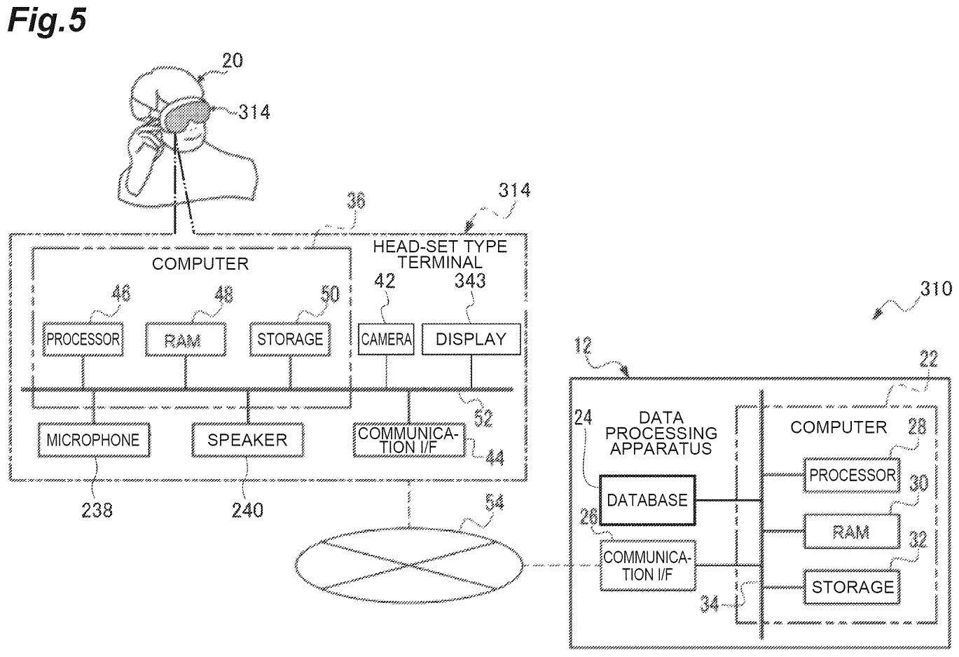

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

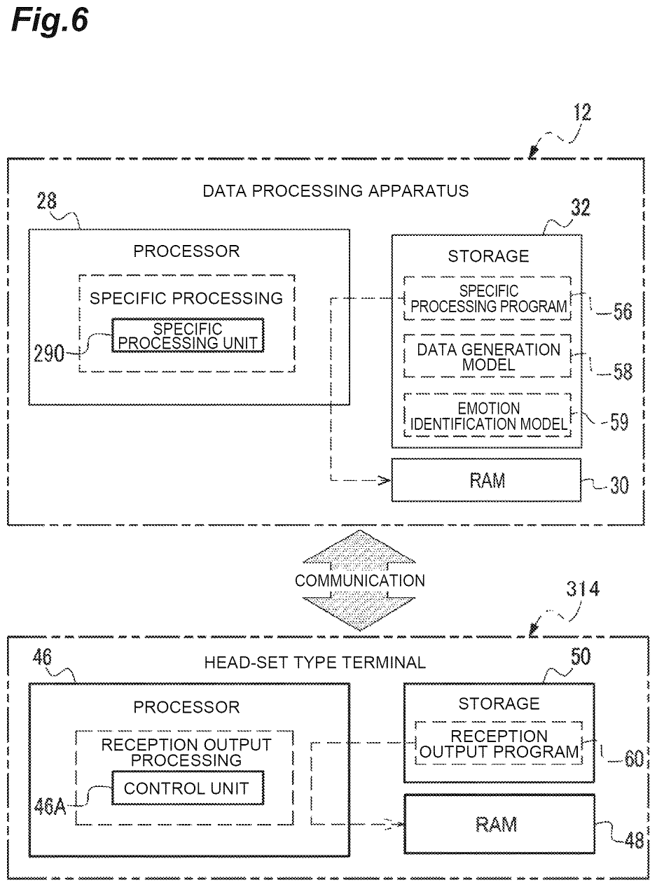

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the headset-type terminal 314.

### Fourth Embodiment

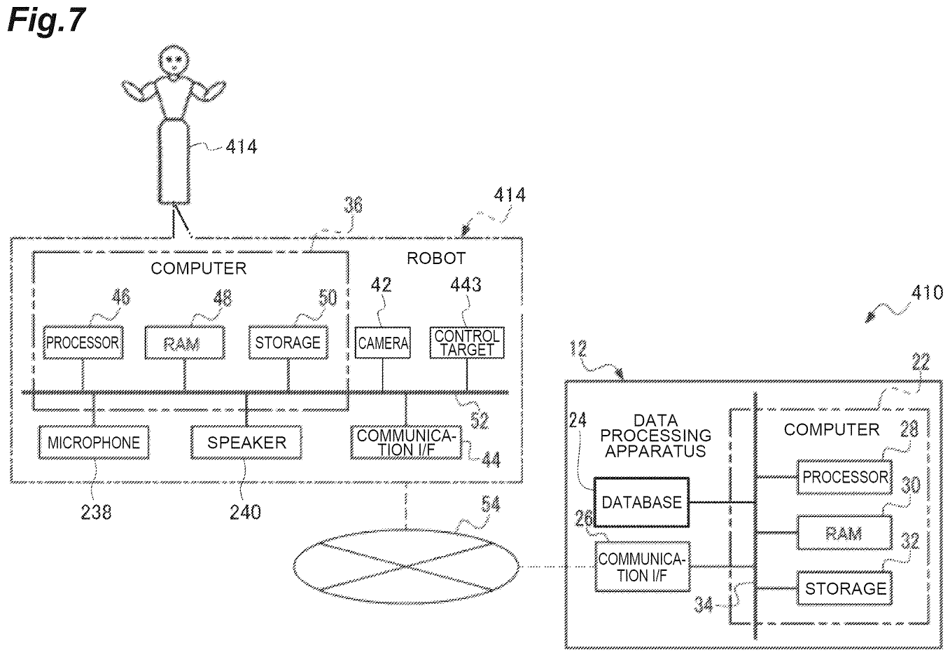

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

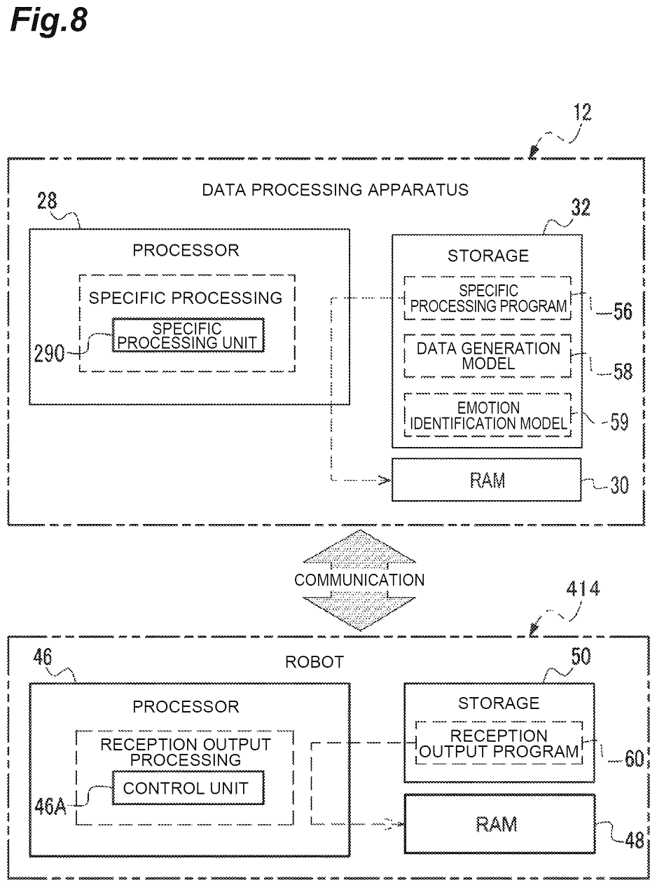

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the robot 414.

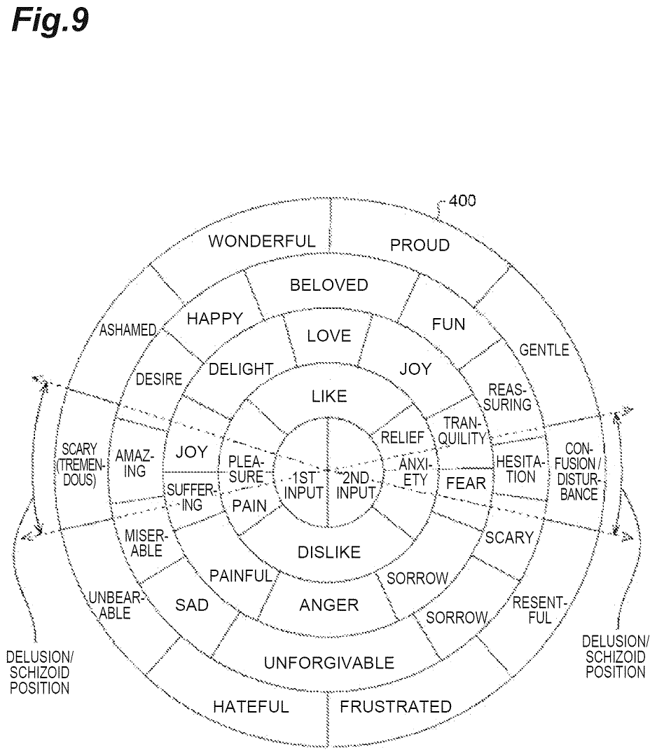

Note that the emotion identification model 59 as an emotion engine may determine a user's emotion according to a specific mapping. Specifically, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.ni.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

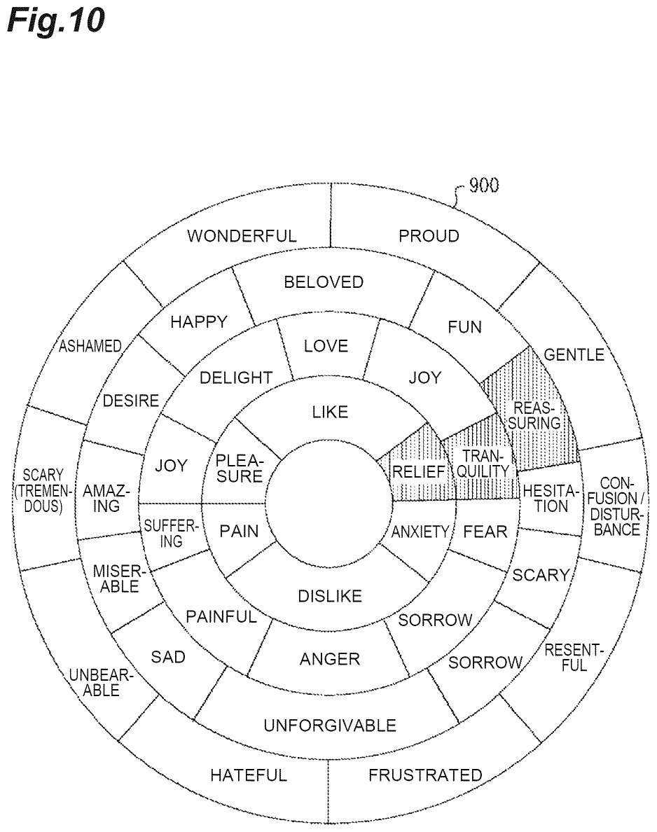

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Determination of emotion by the emotion identification model 59 may be performed by the following vector calculation. The emotion map 400 or 900 is defined as a two-dimensional or three-dimensional vector space. The specific processing unit 290 calculates an “input emotion vector” from prosodic features (pitch, intensity, speech speed) of the user's voice and/or facial expression feature points in the video. Next, the specific processing unit 290 calculates a Cosine Similarity between this input emotion vector and a plurality of “reference emotion vectors (e.g., relief, fear, joy)” arranged on the emotion map. A reference emotion with the highest similarity (closest angle) is identified as the current emotion. Furthermore, when the magnitude of the identified emotion vector exceeds a predetermined threshold, the generation unit performs weighting processing to add a specific adjective or adverb (e.g., “slowly”, “safely”) for calming or amplifying the emotion in the description text to be generated.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a SaaS (Software as a Service) format.

In the above embodiment, an example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

In the above embodiment, an example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, more specifically, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

Regarding the above embodiments, the following is further disclosed.

### Application Example 1

A system comprising a camera unit, an analysis unit, a generation unit, a speech synthesis unit, and an output unit. The camera unit has a function of being installed in a home or a nursing care facility and acquiring video in real time, and a plurality of cameras are attached to a ceiling or a wall and are arranged so as to overlook the entire room. The analysis unit has a function of receiving the video acquired from the camera unit and identifying important elements in the video using computer vision technology, and identifies the arrangement of furniture, objects placed on the floor, the positions of windows and doors, and the presence of other people. The generation unit has a function of generating description text that provides guidance for a user to move safely, based on the information extracted by the analysis unit, and includes specific movement instructions based on the user's current position and destination. The speech synthesis unit has a function of converting the description text generated by the generation unit into natural speech, and the audio is output through earphones or a speaker so as to reach the user's ears directly. The output unit has a function for providing the audio generated by the speech synthesis unit to the user, and can adjust the volume and sound quality according to the user's environment.

The system, wherein the analysis unit identifies a person, an object, a background, and an action in the video, and the generation unit generates description text based on this information. The analysis unit can recognize text information in the video, for example, signs and subtitles, and can utilize this for description. Furthermore, the analysis unit can detect the emotional tone of the video and changes in background music, and can provide this information to the generation unit.

The system, wherein the generation unit generates description text using natural language processing technology based on the feature image or the feature video and information extracted by the analysis unit. The generation unit generates sentences that describe in detail changes in scenes and actions of characters in the video, and the speech synthesis unit converts this into audio with a natural intonation. A specific example of a prompt sentence to be read into the generative AI includes an instruction such as, “In this scene, please describe the actions of the characters and the details of the background. In particular, please consider the influence of the emotional tone and music.”

A system for analyzing video content, comprising circuitry, wherein the circuitry is configured to: input video content; analyze the input video content to extract features in a video; generate description text using natural language processing technology based on the extracted features; convert the generated description text into audio; and output the generated audio.

The system, wherein the circuitry is configured to: identify at least one of a person, an object, a background, and an action in the video content; and generate the description text based on the at least one of the person, the object, the background, and the action.

The system, wherein the circuitry is configured to: analyze each frame of the video using computer vision technology, identify a visual element, and extract a feature image or a feature video.

The system, wherein the circuitry is configured to: receive the extracted feature image or the extracted feature video as input and generate the description text using the natural language processing technology.

The system, wherein the circuitry is configured to: generate a sentence explaining a change in a scene and an action of a character in the video; and convert the sentence into the audio.

A method for analyzing video content, the method comprising: inputting video content; analyzing the input video content to extract features in the video; generating description text using natural language processing technology based on the extracted features; converting the generated description text into audio; and outputting the generated audio.

1. A system for analyzing video content,
comprising circuitry,
wherein the circuitry is configured to:
input video content;
analyze the input video content to extract features in a video;
generate description text using natural language processing technology based on the extracted features;
convert the generated description text into audio; and
output the generated audio.

2. The system according to claim 1,
wherein the circuitry is configured to:
identify at least one of a person, an object, a background, and an action in the video content; and
generate the description text based on the at least one of the person, the object, the background, and the action.

3. The system according to claim 1,
wherein the circuitry is configured to:
analyze each frame of the video using computer vision technology, identify a visual element, and extract a feature image or a feature video.

4. The system according to claim 1,
wherein the circuitry is configured to:
receive the extracted feature image or the extracted feature video as input and generate the description text using the natural language processing technology.

5. The system according to claim 1,
wherein the circuitry is configured to:
generate a sentence explaining a change in a scene and an action of a character in the video; and
convert the sentence into the audio.

6. A method for analyzing video content, the method comprising:
inputting video content;
analyzing the input video content to extract features in the video;
generating description text using natural language processing technology based on the extracted features;
converting the generated description text into audio; and
outputting the generated audio.
